(19) United States
(12) Patent Application Publication
(10) Pub. No.: US 2012/0175215 A1
(43) Pub. Date: Jul. 12, 2012

(54) ELECTROMECHANICAL ACTUATING ASSEMBLY

(75) Inventors: Benjamin Schneider, Friedrichshafen (DE); Gerhard Gumpoltsberger, Friedrichshafen (DE)

(73) Assignee: ZF FRIEDRICHSHAFEN AG, Friedrichshafen (DE)

(21) Appl. No.: 13/391,425

(22) PCT Filed: Aug. 12, 2010
(86) PCT No.: PCT/EP10/61776

§ 371 Date: Mar. 14, 2012

(30) Foreign Application Priority Data
Aug. 31, 2009 (DE) 10 2009 029 006.0

(51) Int. Cl. F16D 13/56

(52) U.S. Cl. 192/90; 192/89.2

(57) ABSTRACT

An electromechanical actuating assembly for at least one actuator element of a vehicle transmission. The assembly comprising a drive device which is coupled with an actuating device for actuating an actuator element. The actuating device has a spring system which is in an operative connection with a ball ramp, and an adjustment mechanism for adjusting the effective actuator force, of the ball ramp, for actuating the actuator element.

This application is a national stage completion of PCT/EP2010/061776 filed Aug. 12, 2010 which claims priority from German Application Serial No. 10 2009 029 006.0 filed Aug. 31, 2009.

### FIELD OF THE INVENTION

The present invention concerns an electromechanical actuating assembly for at least one actuator element of a vehicle transmission.

### BACKGROUND OF THE INVENTION

Known in the vehicle technology is the fact that actuator elements in automatic transmissions are actuated hydraulically. For that purpose, an oil pump is driven by the crank shaft of the combustion engine of the vehicle, and whereby through the hydraulic system, via a control device, respective control valves move a piston to actuate the actuator elements. Besides the significant space needed to for the hydraulic actuation, another disadvantage arises because actuation of the actuator element is only possible with a running combustion engine. Thus, the start-stop function and hybrid ability of the vehicle is limited.

In addition, an electromechanical clutch is known through the publication DE 102 36 516 A1 wherein the required pressure force in the clutch is created through a ring shaped ramp system. The ramp system is moved via an electric drive in a way such that an axial force is created by means of rotating the transfer ring of the ramp system and is brought to a pressure plate of the clutch to engage the clutch. It is hereby required that the electric drive is designed so that it generates the required pressing force or actuating force, respectively.

### SUMMARY OF THE INVENTION

The object of the present invention is to propose an electromechanical actuating assembly in accordance with the above described type, which requires minimum assembly space and also a lower drive power.

Thus, an electromechanical actuating device is proposed for at least one actuator element, in particular a load actuator element in an automatic transmission, with at least one drive direction and which is coupled to an actuator device for actuating the actuator element, wherein the actuator device comprises of at least one spring system which is in an operative connection with a ball ramp or similar, and which has an adjustment mechanism to adjust the actual spring force towards the ball ramp for actuation of the actuator element.

Spring compensated actuation of the actuator element is realized by means of the inventive actuating assembly, with a predetermined spring force for the adjustment of the desired actuating force, just the direction of the actual spring force towards the ball ramp is changed by the drive device, which only requires a low amount if power for large actuating forces. The change of direction and the spring system takes place electromechanically via the adjustment mechanism which is actuated by the drive device. In this compensated system, large actuating forces can be stored as potential energy via the spring system, whereby the drive device just operates the system or rather adjusts the direction of the force of the spring system which requires, in comparison, a low amount electric power.

In addition, a savings of power can be achieved through the electromechanical actuating assembly as compared to a hydraulic drive, due to the reduction of the required hydraulic power. Also, it creates a better power matching with this invention for the requirement of the energy supply through the on board electrical power. In addition, expensive ducts and hydraulic parts which are required for a hydraulic drive can be omitted. An additional advantage in this inventive actuating assembly is that a start-stop function of the combustion engine and of a hybrid drive can be realized.

In an especially advantageous embodiment of the invention it can be provided that the adjustment mechanism comprises of at least a rotatable ring gear segment or similar, to which one end of the ring system is attached, whereby the other end of the spring system is connected, via a lever element or similar, with a first ring half of the ball ramp. Thus, a ring gear segment or rather a ring gear can be used to adjust the direction of the force of the spring system and the resulting torque at the ball ramp, and the ring gear causes, for instance, an adjustment of the direction of the spring force through an electrically driven gear wheel. If the line of force of the spring system runs through the axial center or the rotational axis of the ball ramp, there is no torque or rather actuating force at the ball ramp so that the present spring force of the spring system does not cause actuation of the actuator element or the multidisc plate clutch, respectively. By adjusting the line of force of the spring system tangentially to the rotational axis of the ball ramp, the actuator torque at the ball ramp is maximized and therefore the actuator force at the actuator element which needs to be actuated is maximum. Intermediate positions allow values of the actuator force to range between zero and the maximum actuating force.

To transmit the predetermined actuating force to the actuator element, it can be provided in another embodiment, in accordance with the invention, that the ball ramp is coupled with an actuator element or similar which transforms the rotation of the ball ramp into an effective actuating force at the actuator element. For instance, the actuator element can be moved during rotation of the ball ramp through a second ring half, provided with the respective ramp contour, in the axial direction of the disc package of the multidisc plate clutch, designed as the actuator element, to create the predetermined actuator force. Thus, the actuator element can be moved axially by the rotation of the ball ramp or the second ring half of the ball ramp, so that the potential energy, which is created through the spring system, can be transferred as actuator force to the multidisc plate clutch.

Two interlaced springs or similar can be used for instance as a spring system. Other spring mechanisms or the application of just one spring are possible.

To enable a compact construction, it can be for instance provided that at least the spring system and the adjustment mechanism, are positioned radially outside with reference to the multidisc plate clutch which is designed as actuator element, in the transmission enclosure. However, other positioning options are possible.

### BRIEF DESCRIPTION OF THE DRAWINGS

Hereafter, the present invention is further explained based on the drawings. It shows:

FIG. 1 a schematic presentation of the general operating principle of the inventive actuator configuration for an actuator configuration

FIG. 2 a sectional partial view of the inventive actuator configuration; and

FIG. 3 a sectional view along the section line 3-3 in accordance with FIG. 2

### DETAILED DESCRIPTION OF THE PREFERRED EMBODIMENTS

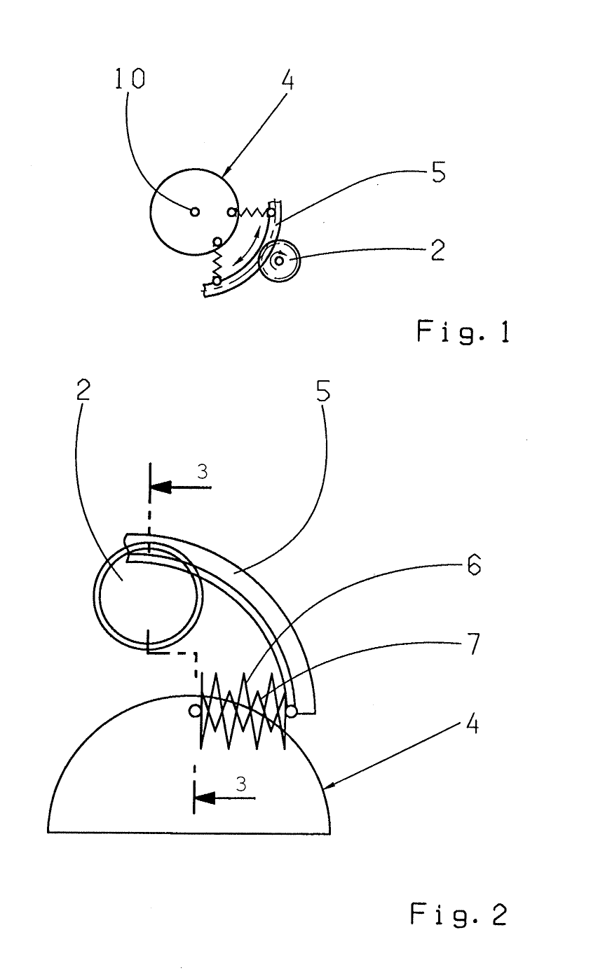

FIG. 1 shows a drawing of the general operating principle of the proposed electromechanical actuating assembly. It can be seen in the presentation that the actuating assembly comprises a drive device of an electric motor 1 which drives a drive gear wheel 2, wherein the drive device of an actuator device is coupled with the actuator element which is designed as a multidisc clutch 3. The actuator device comprises of a spring system which is in an operative connection with a ball ramp 4, and an adjustment mechanism to adjust the actuator force which is present at the ball ramp 4 to actuate the multidisc clutch 3. As an adjustment mechanism a ring gear segment 5 is provided which can be rotated by the drive gear wheel 2. Shown, as examples, in FIG. 1 are just two positions of the adjustment mechanism. A double arrow indicates that additional interim positions are possible between the two positions of the shown adjustment mechanism.

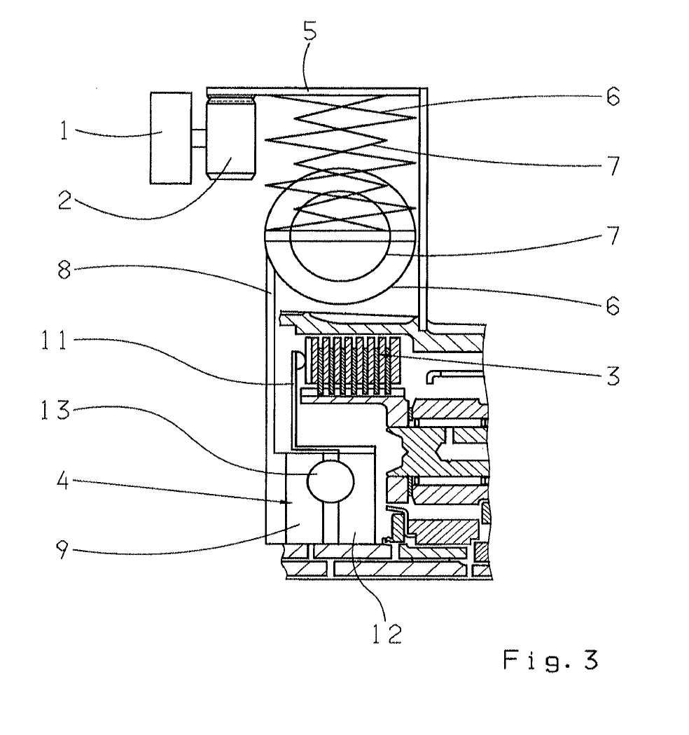

FIGS. 2 and 3 shows a possible embodiment variation of the inventive actuating assembly. For the spring system, two interlaced springs 6, 7 are provided wherein first end of each of the springs 6, 7 is attached to the rotatable ring gear segment 5, and the second end of each of the springs 6, 7 is attached, via a lever element 8, to a first ring half 9 of the ball ramp 4.

In FIG. 2, the adjustment mechanism or the ring gear segment 5 is presented in a way that the spring force or rather the force vector of the springs 6, 7 are adjusted in parallel to the rotational axis 10 of the ball ramp 4, so that the spring force becomes effective, via the lever element 8, in the circumferential direction at the first ring half 9 of the ball ramp 4. That condition causes a maximum actuating torque at the ball ramp 4.

FIG. 3 shows, among other things, a position of the ring gear segment 5 in which the spring force of the springs 6, 7 is directed towards the rotational axis 10 of the ball ramp 4, so that no spring force or rather actuating torque becomes effective at the ball ramp 4. Thus, this condition does not create an actuating force at the multidisc plate clutch 3 which has to be actuated. In particular, it can also be seen in FIG. 3 that the generated spring force at the ball ramp 4 is transferred, via an actuator element 11, to the disc packet of the multidisc clutch 3. Hereby, the actuator element is coupled with the second ring half 12 of the ball ramp 4 designed with the respective ramp contour. Thus, axial movement of the actuator element 11 can be generated during rotation of the second ring half 12, such that it is moved in the direction of the disc packet of the multidisc clutch 3 to generate a predetermined actuating force. The two ring halves 9, 12 are linked to each other via the roller elements 13.

In the proposed actuating assembly, the ball ramp 4 actuates directly, via the actuating element 11, the disc packet of the multidisc clutch 3. The ball ramp 4 is actuated via the spring system and the direction of the force or rather the force vector can be varied by the adjustment mechanism. The spring system acts, via the lever element, with the ball ramp 4, wherein the direction of the spring force can be changed by the gearing of the ring gear 5 of the adjustment mechanism. Preferably, the adjustment mechanism can be positioned radially, outside of the disc packet of the multidisc clutch 3. Thus, the actuating assembly controls the rotational angle for the actuation of the multidisc clutch 3.

### REFERENCE CHARACTERS

1. Electric Motor

1. Drive Gear Wheel

2. Multidisc Clutch

3. Ball Ramp

4. Ring Gear Segment

5. Spring

6. Spring

7. Lever Element

8. First ring half of the Ball Ramp

9. Rotational axis of the Ball Ramp

10. Actuator Element

11. Second ring half of the Ball Ramp

12. Roller Element

1-8. (canceled)

9. An electromechanical actuating assembly for at least one actuator element of a vehicle transmission, the actuating assembly comprising:
at least a drive device which is coupled with an actuating device for actuating an actuator element, and the actuating device having at least a spring system which is in an operative connection with a ball ramp (4), and
an adjustment mechanism for adjusting an effective actuator force of the ball ramp (4) for the actuation of the actuator element.

10. The electromechanical actuating assembly according to claim 9, wherein the adjustment mechanism is rotatable, via a drive device, and comprises at least a ring gear segment (5) to which one end of the spring system is attached, while an opposite end of the spring system is linked, via a lever element (8), with the ball ramp (4).

11. The electromechanical actuating assembly according to claim 10, wherein a direction of the spring force of the spring system is adjusted tangentially to the rotational axis (10) of the ball ramp (4) and the spring force of the spring system is effective, via the lever element (8), in the circumferential direction at a first ring half (9) of the ball ramp (4) for generating a maximum actuator force.

12. The electromechanical actuating assembly according to claim 10, wherein, when no actuator force is necessary, a spring force of the spring system is adjusted radially to the rotational axis (10) of the ball ramp (4), via the lever element (8).

13. The electromechanical actuating assembly according to claim 9, wherein the actuator force of the ball ramp (4) is transmitted, via an actuating element (11), to the multidisc clutch (3) which is designed as an actuating element.

14. The electromechanical actuating assembly according to claim 11, wherein, upon rotation of the ball ramp (4), the actuating element (11) is moved, by a second ring half (12) which is designed with a respective ramp contour, in an axial direction of a disc packet of the multidisc clutch (3) to generate a predetermined actuating force.

15. The electromechanical actuating assembly according to claim 9, wherein the spring system comprises two interlaced springs (6, 7).

16. The electromechanical actuating assembly according to claim 10, wherein at least the spring system and the adjustment mechanism are positioned radially outside of the multidisc clutch (3), which is designed as the actuator element.

17. An electromechanical assembly for actuating a clutch of a vehicle transmission, the actuating assembly comprising:
a drive device which is coupled with an actuating device for actuating the clutch, and the actuating device having a spring system which is operatively connected with a ball ramp (4), and
an adjustment mechanism for adjusting an effective force of the ball ramp (4) for actuating the clutch.

18. The electromechanical actuating assembly according to claim 17, wherein the adjustment mechanism is rotatable, via a drive device, and comprises at least a ring gear segment (5) to which one end of the spring system is attached, while an opposite end of the spring system is linked, via a lever element (8), with the ball ramp (4); and
a direction of the spring force of the spring system is adjusted tangentially to the rotational axis (10) of the ball ramp (4) and the spring force of the spring system is transferred, via the lever element (8), to a first ring half (9) of the ball ramp (4) for generating a maximum actuator force.

19. The electromechanical actuating assembly according to claim 18, wherein the actuator force of the ball ramp (4) is transmitted, via an actuating element (11), to the multidisc clutch (3) which is designed as an actuating element; and
upon rotation of the ball ramp (4), the actuating element (11) is moved, by a second ring half (12) which has a ramp contour, in an axial direction of a disc packet of the multidisc clutch (3) to generate a predetermined actuating force.

20. The electromechanical actuating assembly according to claim 19, wherein the spring system comprises two interlaced springs (6, 7).
